(19) United States
(12) Patent Application Publication
(10) Pub. No.: US 2003/0149717 A1
(43) Pub. Date: Aug. 7, 2003

(54) Batch processing job streams using and/or precedence logic

(76) Inventor: William Heinzman, Boulder, CO (US)

Correspondence Address: MARSH, FISCHMANN & BREYFOGLE LLP, 3151 SOUTH VAUGHN WAY, SUITE 411, AURORA, CO, 80014, US

(21) Appl. No.: 10/355,367

(22) Filed: Jan. 31, 2003

Related U.S. Application Data
(60) Provisional application No. 60/354,906, filed on Feb. 5, 2002.

(51) Int. Cl. G06F 9/00

(52) U.S. Cl. 709/101

(57) ABSTRACT

A product and associated methodology provided for scheduling job streams and leveling machine loads automatically without regard to specific knowledge of a job's internals or estimates of its machine load and without specific knowledge of a machine's resources or its total machine load capability. This involves use of a generalized critical path method algorithm in conjunction with a resource leveling algorithm. The generalized CPM algorithm supports arbitrary precedence logic and precedence types. The invention can therefore provide automatic resource leveling in connection with a broad range of practical applications including managing resources of a computer network.

### RELATED APPLICATIONS

This patent application claims priority from U.S. Patent Application Serial No. 60/354,906, that was filed on Feb. 5, 2002, and which is entitled “BATCH PROCESSING JOB STREAMS USING AND/OR PRECEDENCE LOGIC”. The entire disclosure of U.S. Patent Application Serial No. 60/354,906 is incorporated herein by reference.

### FIELD OF THE INVENTION

The present invention generally relates to analysis and optimization of batch processing job streams such as by a scheduler and, in particular, to a system for simulating, analyzing and optimizing such job streams that accommodates arbitrary precedences (including both AND and OR precedences) and utilizes both a critical path method and minimum moment resource leveling.

### BACKGROUND OF THE INVENTION

Corporations today are required to implement and participate in computerized business infrastructure, hence the existence of information technology (IT) departments. From the very beginning of IT, batch processing has been a key task necessary to a functioning business. Initially, batch processing was an integral part of early mainframes where all jobs within a batch process were run on one machine. As such, a software component called a “scheduler” was required to manage the processing of the batch jobs. Since the jobs needed to be run in a particular order, i.e. exhibited a dependency order of predecessors and successors, the jobs in batch processing are referred to as a “job stream”.

While mainframe schedulers were integral to the operating system of the mainframe, third-party scheduler applications could be purchased and installed to manage job streams, as well. In the 1990s with the growth of company wide intranets, batch processing became distributed across a company's mainframes, servers, workstations and desktop PCs. Scheduler applications to handle processing on heterogeneous distributed CPUs became available in the early 1990s. Schedulers provide functionality in three areas: job stream creation, managing job stream execution and job stream monitoring.

IT departments are tasked with running job streams successfully, in a certain amount of time, on a finite numbers of machines. Successful execution is achieved through careful job stream design, use of events and alarms and monitoring. Given a successful run, the overall time required to complete a job stream is governed by several factors. Some of these factors are independent, others are dependent.

Assuming all other factors equal, the smallest amount of time for a job stream to execute depends on the number of jobs, the predecessor/successor hierarchy of the job stream, the execution time for each job, and inherent overheads that contribute to latency such as communications or the execution speed of the scheduler itself. These factors can be termed dependent factors. In other words, the job stream must have a finite execution time. Other dependent factors can be external constraints placed on the job stream that are not controlled by the scheduler. An example of this would be a job that must wait for a file to download from an external source.

Independent or controllable factors are related to the environment upon which the job stream executes: the corporate IT infrastructure, its machines, peripherals and network bandwidth. Any given job stream will, as a rule, run faster when using numerous and more powerful computers connected to greater bandwidth. Any given job stream will run slower on a few computers heavily loaded with many concurrent jobs from the same and other job streams, connected to saturated bandwidth. Therefore, a given IT infrastructure consisting of computers (CPUs, memory, disks, and I/O), peripherals (tape drives, printers, or other machines) and a network (hubs, routers, firewalls and connections to the internet), has an upper limit of performance that will affect job stream execution times. This upper limit is quickly reached as the execution times and number of jobs increase. These increases, tied to corporate growth, will saturate any given IT infrastructure over time.

Managing job loads on a given IT infrastructure and avoiding saturation is a major concern to IT departments; machines are the critical resource. Resorting to machine, peripheral or network upgrades and purchases is capital intensive. Some schedulers provide a means of optimizing job loads. All of these means are empirical: they require a numeric estimate, machine load units (MLUs), for example, of machine resources a given job will require and an estimate of the total MLUs of which a machine is capable. The scheduler can use this knowledge to queue jobs or, if a pool of machines capable of running a given job has been defined, move a job to another machine within the pool. Queuing up jobs results in longer job stream execution times, it just avoids saturating a machine. Moving jobs about the machines in a pool reflects only that the current IT infrastructure has not been saturated; it avoids saturating any one machine without the delays inherent to a queuing strategy. Once the machines in the pool are saturated, queuing must be used and execution times increase.

Estimating machine and job load factors is difficult. An IT technician administrating a scheduler must know what a job does specifically and what machine resources are needed by that job (is it CPU intensive or disk intensive, for example). In many cases jobs and job streams are defined by other individuals in other corporate departments, or are undocumented, cryptic scripts—specific knowledge about the job may be unavailable. If a scheduler administrator does know what a job does, load factors are still ballpark estimates, at best. Similarly, the maximum load a machine can take is also an estimate.

### SUMMARY OF THE INVENTION

It has been recognized that a better solution for managing and leveling job streams across a finite set of IT resources is for schedulers to actually schedule. Conventional schedulers only reactively manage starting and stopping jobs, exceptions and events. When a job's predecessors and other constraints have been satisfied, a conventional scheduler will execute that job at that time. Such conventional schedulers generally do not recognize, for example, that it may be possible to delay the start of a job to a later time when machine loads are less without increasing the overall run time of the job stream of which the delayed job is part, i.e., that it may be possible to proactively schedule events rather than wait for and identify opportunities to proceed.

The present invention provides a product and associated methodology for scheduling job streams and leveling machine loads automatically without regard to specific knowledge of a job's internals or estimates of its machine load and without specific knowledge of a machine's resources or its total machine load capability. The present invention also allows for graphically depicting a job stream schedule including float, and allow for better identifying and managing float for enhanced job stream efficiency. Moreover, the present invention can handle arbitrary precedence logic and precedence types so as to address a variety of job stream scenarios.

The Critical Path Method (CPM) constitutes a well known set of algorithms within Computer Science. While these algorithms have broad applicability, they are mostly used commercially in the project management arena. Microsoft Project is an example of an application which does CPM. Very large construction projects (dams, sports arenas, nuclear reactors, office buildings, airports) use sophisticated software packages to manage the project. CPM analysis is a key component to these software packages. However, CPM analysis has generally had very limited applicability to optimization of batch process job streams that have arbitrary precedences, i.e., that are not limited to AND precedences.

In this regard, batch process job streams include a series of functions or jobs relationships with defined precedent governing sequence relationships to be executed on a defined, finite set of network resources as a “batch”, e.g., with little or no user input after initiation of the job stream. The resource set may involve a centralized processor such as a mainframe and associated database tools or may be distributed across multiple processing platforms and storage or other network devices. The nature of such job streams are as varied as the enterprises where they are executed. However, batch processing applications are readily distinguished from construction project management and similar conventional applications where conventional CPM analyses have been employed. In such conventional applications, CPM analysis has been used, for example, to schedule equipment and other resources so as to timely complete a project. The product of such analysis is often a chart or other hard copy reference used by a project manager for planning and monitoring the project. The CPM tool has therefore been mainly a product for generating reference materials used by a decisionmaker in conventional applications.

In batch processing applications in accordance with the present invention, a CPM tool is actively involved in defining a schedule, issuing commands to trigger job execution, monitoring actual run times during execution, rescheduling jobs as required or allowed, providing graphical displays for enhanced planning and monitoring, and generating alarms as needed. Thus, in the context of batch processing, the present invention is not limited to providing reference materials for use by a decisionmaker but in fact makes or executes decisions and dynamically manages job stream execution. In this regard, the algorithms of the present invention can be executed with sufficient efficiency to allow for such substantially real time functionality. While certain aspects of the present invention are applicable to a variety of job stream contexts, such batch processing represents an especially advantageous application of the invention.

The present inventor has determined that CPM algorithms can be adapted so as to be more fully applicable to the optimization of batch process job streams. Current schedulers generally do not use even the conventional CPM to optimize job streams. Moreover, current CPM algorithms are not general enough to support the precedence strategies allowed by most schedulers. If the CPM algorithm is used by a scheduler it is often as a visual tool to aid 24×7 monitoring without effective CPM based forward looking simulation, analysis or optimization. In any event, in most cases where the conventional CPM is said to be used, it is believed that either the CPM is not calculated correctly (for reasons described below), or the term “critical path” is inappropriately used.

There are at least two key areas not believed to be supported by current CPM algorithms:

1. The current CPM algorithms are only specific to AND precedences. Thus, in FIG. 1, Job C cannot run until both Job A AND Job B have run. However, it is possible in any current scheduler to set up any arbitrary logical AND/OR precedence. For example, in FIG. 1, Job I cannot run until Jobs ((F OR G) AND H) have run.

2. The precedence within a job stream can be “typed”. For example, precedence can be of type success, failure, termination, etc . . . . Hence, in accordance with the present invention, a job dependency can be written as: Job D cannot run until: (Success (Job A) OR (Termination (Job B) AND Failure (Job C))) Conventional CPM algorithms only handle a success type of precedence.

In accordance with one aspect of the present invention, a method and apparatus (collectively “utility”) is provided for processing job streams using a generalized Critical Path algorithm that handles any arbitrary AND\OR precedence relationship. The utility involves receiving input information defining a job stream including arbitrary precedence logic, configuring a processor to execute a Critical Path Method (CPM) algorithm adapted to handle the arbitrary precedence logic and employing the processor to process the job stream. The job stream includes at least one AND precedence set such that the execution of a successor job is dependent on an outcome of each of two or more predecessor jobs and at least one OR precedence set such that the execution of a second successor job is dependent on an outcome of less than all of two or more predecessor jobs. The CPM algorithm involves identifying a job path within the job stream where each job on the critical path has an identical early start and late start time upon proper application of all associated precedences. Such an algorithm for handling arbitrary precedence logic is described below. The processor can process the job stream to schedule the various jobs in accordance with a desired optimization criterion, for example, such as resource leveling, to graphically display a potential schedule including associated floats, to provide a graphical or other user interface to allow a user to manipulate a potential schedule and/or to alter scheduling parameters such as adding float to the entire job stream or a portion thereof.

In accordance with another aspect of the present invention, a utility is provided for processing job streams using a generalized critical path algorithm that handles any arbitrary precedence type. The utility involves receiving input information defining a job stream including arbitrary precedence types, configuring a processor to execute a critical path method algorithm adapted to handle the arbitrary precedence types, and employing the processor to process the job stream. The job stream includes at least a first outcome type relating to a first outcome of a first predecessor job and a second outcome type, different from the first outcome type, relating to a second outcome of a second predecessor job. For example, such outcomes may include “success”, “termination”, and “failure.” The CPM algorithm is operative for identifying a critical path within the job stream upon proper application of the associated precedences. An appropriate algorithm is discussed in detail below. The processor may process the job stream to optimize the job stream, graphically depict the job stream including floats, allow for manipulation of a potential schedule by a user, and/or allow for various other processing.

According to a further aspect of the present invention, a utility is provided for processing job streams for improved resource leveling. The utility involves receiving input information defining a job stream, configuring a processor to execute a resource leveling algorithm and employing the processor to process the job stream using the resource leveling algorithm. The job stream may be a simple job stream defined by only one type of logical precedence operator and precedence type or may be a more complicated job stream involving arbitrary precedence logic and/or arbitrary precedence types. The resource leveling algorithm is directed to moderating a usage extremum of at least one resource of a defined resource set. For example, the resource may be an identified processor or information storage unit. Usage of the resource may be leveled by reducing a maximum (or local maximum) usage level of the resource or increasing a minimum (or local minimum) usage level of the resource relative to the execution time period of the job stream. The processor may process the job stream by defining a schedule using the resource leveling algorithm, providing a graphical depiction or other output illustrating the potential enhanced resource usage in accordance with the algorithm or otherwise, processing the job stream.

According to another aspect of the present invention, a utility is provided for utilizing inherited or transferred float to optimize job stream processing. In this regard, inherited float refers to float that is legated from a parent object to a child object of a job stream. Transferred float refers to float that is transferred between jobs having a defined precedence relationship within a job stream.

More specifically, a parent object is any object of the job stream that subsumes more than one child object having a common precedence context within the job stream. An example is a substream composed of multiple jobs. If the substream has a quantity of float within the larger job stream context, that float can be legated to each of the component jobs of the substream. Thus, the float of the substream is not limited to being used to move in time the substream as a unit, but may be used to move in time a particular job with any attendant affects on related jobs.

An associated utility involves receiving input information defining a job stream, identifying a parent object of the job stream having first and second child objects, identifying a float associated with the parent object and configuring a processor to determine a float for one of the first and second child objects that is due at least in part to inheritance from the parent object. In this regard, float refers to a temporal flexibility of at least one of a start time and an end time for executing one of the child jobs. Such inherited floats may be available, for example, where the parent object is not part of a critical path of the overall job stream. The inherited float may be used to vary an execution time of a child job even though that job may be part of a critical path with respect to the parent object, e.g., a local substream. Thus, the inherited float allows for optimization such as for resource leveling even with respect to jobs that might appear to have a critical timing within the local context within the job stream.

Transferred float involves predecessor/successor relationships rather than parent/child relationships. In this regard, a predecessor job is a job defined by precedence relationships of a job stream such that the job is executed at least in part prior to a successor job. That is, the successor job is dependent on the predecessor job. A given job may be predecessor of one or more jobs and a successor of one or more other jobs. Transfer occurs when float of one job is added, subtracted or recharacterized based on movement or execution of a related job. Such transfer may move upstream or downstream with respect to a job stream. For example, a predecessor job may have a quantity of total float but no free float (as discussed in more detail below) because a successor job is scheduled to immediately follow the predecessor job. If the successor job is rescheduled to a later time (e.g., during planning or execution of the job stream), a corresponding interval of the predecessor job's total float is converted to free float, thereby effecting a transfer. Conversely, if a predecessor job has free float and is scheduled to a later time, back float may be subtracted from a successor job. The present invention can accommodate such transfers by displaying floats to facilitate manual scheduling, automatically calculating and recalculating floats associated with transfers, and dynamically rescheduling a job stream, based on such transfers, as a function of monitoring actual execution times.

According to a still further aspect of the present invention, a utility is provided for graphically depicting a job stream schedule including at least one float. The utility involves receiving input information defining a number of jobs to be executed using a defined resource set, and operating a computer system to determine and graphically depict output information including float for at least one of the number of jobs. For example, the output information may be provided in the form of a graph or chart on a graphical user interface that includes graphical elements depicting a start time, an end time and a float, such as a total float or free float as discussed below for a particular job. In one implementation, the schedule for a job stream is depicted on a graph where one axis identifies jobs or loading and another axis identifies time such that the run times and floats for each job can be graphically depicted in a single panel. Such graphical depictions including float may assist a user in manually rescheduling a job stream or determining the criticality of an alarm or job delay.

According to another aspect of the present invention, a utility is provided for allowing a user to reschedule a job stream via a simple command entered relative to a graphical user interface. The utility involves receiving input information defining a job stream, operating a computer system to graphically depict a usage graph reflecting a usage level of at least one resource of a resource set over a time period corresponding to execution of at least a portion of the job stream, receiving via the graphical user interface a user input for altering a portion of the usage graph, and operating the computer system to alter the job stream schedule based on the user input. For example, the computer system may first be operated in accordance with the present invention to determine and graphically display a proposed schedule for a job stream. The graphical display may show at least the run times for various jobs depicted as graphical elements. In one implementation, the user may drag and drop the graphical element corresponding to a particular job so as to reschedule that job. The logic of the present invention may monitor such manual inputs so as to prevent, or otherwise provide warnings in connection with, inputs that violate predefined criteria, such as proposed movements that increase the run time of the overall job stream or result in undesired usage levels of machine resources. The computer system may further be operative to recalculate and display scheduling information based on the change. In this manner, the expertise of a user may be leveraged while taking advantage of the processing capabilities of the present invention.

According to a still further aspect of the present invention, scheduling information including a determined float time are used to determine the time for triggering an alarm. In some cases, conventional schedulers trigger alarms when a job is believed to be delaying the job stream. In this regard, such conventional systems may monitor a duration of a job or an end time of a job. Such schedulers generally do not involve any consideration of float times. The utility of the present invention involves receiving input information defining a job stream, operating a computer system to determine first information related to an execution time of a job and second information relating to a float time of the job, and operating the computer system to determine a time for triggering an alarm based at least in part on the information relating to the float time of the first job. In this manner, float time may be considered in triggering an alarm so as to avoid an unnecessary alarm.

According to a further aspect of the present invention, a utility is provided for using “back float” in determining a schedule for a job stream. The utility involves receiving input information defining a job stream, operating a computer system to identify a back float for a first successor job and using the back float to determine an actual starting time for the first successor job. In this regard, the back float relates to a flexibility to move a scheduled starting time of the first successor time without rescheduling a preceding predecessor job. Thus, jobs within a job stream may be moved forward or backward in time to optimize a job stream schedule, such as to level resource usage.

According to a still further aspect of the present invention, a utility is provided for adding float to an entire job stream. The utility involves receiving input information defining a job stream, operating a computer system to add float time to the entire job stream and operating a computer system to use the input information defining the job stream and the edited float time to schedule execution of the job stream. In this manner, flexibility may be provided as to the execution time of jobs within the job stream, including jobs located on a critical path. Such float may be useful, for example, to improve resource usage in relation to resource loading from sources outside of the job stream. Such float may be added by way of a simple graphical interface element as will be described in more detail below.

### BRIEF DESCRIPTION OF THE DRAWINGS

For a more complete understanding of the present invention and further advantages thereof, reference is now made to the following Detailed Description taken in conjunction with the drawings, in which:

FIG. 1 is a graphical representation of a job stream that is processed in accordance with the present invention;

FIG. 2 is a graphical representation of another job stream that is processed in accordance with the present invention;

FIG. 3 is a graphical representation of the job stream of FIG. 1 with the critical path jobs, as identified in accordance with the present invention, identified by shading;

FIG. 4 is a screen shot showing a job stream schedule and an associated Gantt chart generated in accordance with the present invention;

FIG. 5 is a histogram representing job loads that can be leveled in accordance with the present invention;

FIG. 6 shows a chart, generally corresponding to the job loads of FIG. 3, where the non-critical path jobs are rescheduled to minimize job load together with a leveled job load histogram;

FIG. 7 is a screen shot showing a chart, generally corresponding to the job loads of FIG. 4, where the non-critical path jobs are rescheduled to minimize job load together with a leveled job load histogram;

FIG. 8 is a screen shot, similar to FIG. 7, showing a run-time graphical user interface; and

FIG. 9 is a screen shot, similar to FIG. 8, where 5 minutes of float has been added to the entire job stream for improved resource leveling.

### DETAILED DESCRIPTION

In the following description, the invention is set forth in the context of a software product and related functionality and structure identified by the trademark “Optimizer” of Fountainhead Software, LLC. While the Optimizer™ system represents an advantageous implementation of the invention, it will be appreciated that various aspects of the invention may be implemented in alternate fashions. Accordingly, the following description should be understood as exemplifying the invention and not by way of limitation.

The Optimizer™ system of the present invention may be implemented as a software product which provides automatic scheduling and leveling of machine loads on machines running a given job stream. In this regard, the Optimizer software works in collaboration with a scheduler application, e.g., a third-party software package manufactured by companies such as Computer Associates or IBM to provide unique functionality.

The Optimizer™ system levels job loads by automatically creating an alternate schedule that flattens machine loads without requiring extensive knowledge about jobs or machines and without any modifications to the existing job stream including external constraints or predecessor/successor dependencies.

Job Streams, Dependencies and Precedent Logic

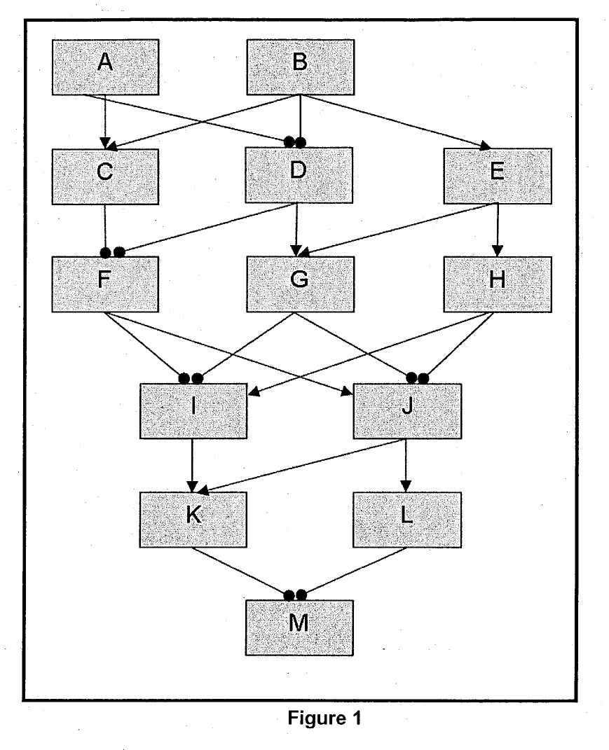

Initially, it is useful to understand the concepts of job streams, dependencies and precedent logic. FIG. 1 graphically represents a job stream. As will be discussed in more detail below, a job stream may be divided into substreams or include contingent paths. FIG. 1 thus represents a relatively simple job stream for purposes of illustrating some fundamental concepts. In FIG. 1, the arrows denote the dependency between predecessors and successors. An arrow that ends in an arrowhead is an AND precedence; one that ends in a ball is an OR precedence. Hence, job J is dependent on jobs: (G OR H) AND F; job/is dependent on jobs: (F OR G) and H.

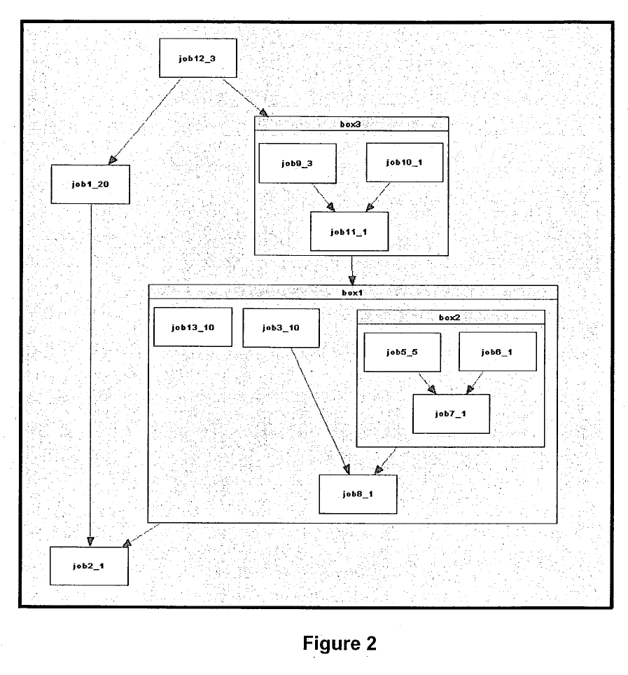

FIG. 2 shows another job stream, represented as a schematic, which illustrates a more complex structure. The illustrated job stream generically consists of three types of objects: smaller, contained substreams (labeled as boxes), jobs, and dependencies. A job is an atomic unit of work, a single process constituting some amount of work which is not broken down into smaller tasks and therefore constitutes the basic element of a job stream. A job stream is some amount of work for which scheduling and/or work flow optimization is desired. This job stream may be broken down into separate, smaller substreams which, in turn, can be distilled into jobs. This is a representation of the intuitive process of breaking down tasks into smaller and smaller subtasks. As discussed below, it is often useful to define portions of the job stream as a substream for purposes of optimization processing. In such cases, a substream job's context within the job stream may be maintained by the properties of inheritance and legacy as discussed below. The dependencies, represented as arrows, enforce a sequence of execution between the jobs and job streams. In total, this represents a schedule.

One important distinction between jobs and job streams is that only jobs use machine resources. The group of jobs that form a job stream is an abstraction. This abstraction can have dependencies on other jobs, but ultimately it is only composed of atomic jobs forming a virtual group with like dependencies and a common task. This is an important distinction when the Optimizer™ system levels machine loads.

Importation of a Job Stream

The first action requires that a job stream be imported into the application. This may be achieved by several steps, one of which is to load a file which contains descriptions of the jobs. Historically, schedulers typically use a job description or command language (JIL/JCL) implemented as an ASCII file (readable and writable by word processors). The following code is an example of a portion of a JIL file:

insert_job: job11_1

box_name: box3

condition: success(job9_3) AND success(job10_1)

job_type: c

alarm_if_fail: y

auto_hold: n

box_terminator: n

command: “c:\tmp\30s.bat”

date_conditions: n

job_terminator: n

machine: brahms

This language is used to load job descriptions, which constitute a job stream, into the scheduler application. With the Optimizer™ system, these files are used to import the job stream into the application. It will be appreciated that information defining a job stream can be received in any appropriate way.

A job has four parameters or execution times which are the outcome of CPM analysis: Early Start (ES), Early Finish (EF), Late Start (LS) and Late Finish (LF) where any difference between the Early Start and the Late Start times, as well as the difference between the Early Finish and Late Finish times, define a temporal flexibility or float with regard to execution of a job without delaying completion of the job stream. It is this float that can be exploited by the present invention to optimize scheduling relative to a defined criterion, such as machine load leveling. Any job which has the same ES and LS times (and, given a duration, the same EF and LF times) is on the critical path: any increase in the duration of this job will delay the finish of the job stream. Any job not on the critical path has different ES and LS times (and, hence, different EF and LF times). In other words a non-critical path job may be able to run within a window and not increase the duration of the entire job stream of which it is a part.

Thus, once the job descriptions have been loaded into the Optimizer™ system, start and end times are associated with each job and the smaller, contained substreams. This can be done in at least two ways. The first is to add two tag/value pairs to the JIL file for each job: ‘start_time:’ and ‘end_time:’. Each tag is followed by a number representing absolute time, e.g., in coordinated universal time format (UTC), an international standard. The second approach is to download the start and end times from the scheduler database directly using the History menu choice. The first approach may be used for two reasons: (1) The job stream has not run within the scheduler, or (2) The jobs in the JIL file represent an incremental addition to a job stream which has already been optimized and executed by the Optimizer™ system.

This initial historical data represents the default or opportunistic behavior of the scheduler. Once a job stream has been optimized, any additions or modifications to that job stream within the scheduler must be also added to the Optimizer™ system. A job stream which has been continually optimized and executed by the Optimizer™ generally will not be run with default behavior just to obtain opportunistic runtimes. Therefore, the incremental loading of JIL files with associated estimated execution times Addresses this issue.

Once the historical data has been loaded into the Optimizer™ system as part of the import process the analysis can begin. This analysis uses the generalized CPM algorithm of the present invention to determine the critical path jobs and the Free and Total Floats of the non-critical path jobs. It will thus be appreciated that the Optimizer™ system may be provided with two inputs: 1) a job stream definition that establishes depending relationships and 2) information initially establishing job durations. The Optimizer™ system then operates in accordance with the present invention to determine execution times and optimize job stream scheduling.

A Generalized Critical Path Method Algorithm for AND/OR Precedence

Given an activity-on-node graph, G (see, e.g., FIG. 1), exhibiting AND/OR precedence, the algorithm for calculating critical path in accordance with the present invention may include a forward and backward pass. The forward pass produces the Early Start (ES) and Early Finish (EF) times; the backward pass produces the Late Start (LS) and Late Finish (LF) times. The graph, G, has duration D_{G}.

An activity on the critical path has the same Early Start and Late Start times, and, given Duration (D), has the same Early Finish and Late Finish times. As noted above, an activity with different ES and LS times such that ES<LS (and subsequently EF<LF), is not on the critical path. Moreover, the span of time between ES and LS constitutes a window in which the activity can float. The activity's start time can either be delayed or, alternatively, the duration of the activity can increase.

Two types of float exist for each activity: Free Float (FF) and Total Float (TF). Free Float is the amount of time an activity can be delayed (or increase in duration) without causing a delay in the ES time of its successors. Total Float is the amount of time an activity can be delayed (or increase in duration) without delaying the finish time of the entire graph, G. These two floats, FF and TF, are calculated on a final forward pass using the four times ES, LS, EF and LF. The standard CPM algorithm is well known, and has been used for activity-on-node graphs exhibiting only AND precedence. The following algorithm has been generalized to correctly calculate all six times for any activity-on-node graph with AND/OR precedence of any arbitrary nesting.

Early Start/Finish

For activity j with predecessors i through n and duration D, the Early Start
time (ESⱼ) is calculated as:

If j is dependent on an OR clause, then:ESⱼ = minimum ( EF_{i . . . n})
Else If dependent on an AND clause, then:

ESⱼ = maximum ( EF_{i . . . n})

Complex clauses, e.g. (A OR B) AND C, are resolved:

ESⱼ = max( min(EF_{A}, EF_{B}), EF_{c}))
The Early Finish time (EFⱼ) is calculated as
EFⱼ = ESⱼ + Dⱼ

Late Start/Finish

For activity i with successors j through m, the Late Finish (LF₁) is cal-
culated:

For any successors for which i is an AND precedent:

LFᵢ = minimum ( LS_{j . . . m}), all OR precedents are ignored

For all successors for which i is only an OR precedent:

LFᵢ = minimum ( LS_{j . . . m}), where ES_{j . . . m} = EFᵢ

If, for all successors j through m, for which i is only an OR precedent
and ES_{j . . . m} ≠ EF, or i has no successors:

LFᵢ = D_{G}

For activity i, the Late Start (LSᵢ) is calculated:

LSᵢ = LFᵢ − Dᵢ

Free Float

For activity i with successors j through m, the Free Float (FFᵢ) is cal-
culated:

If i has more than one successor, then

If precedent clauses are heterogeneous (AND and OR), then

FFᵢ = minimum ( ES_{j . . . m}) − ESᵢ − Dᵢ, where ES_{j . . . m} = EFᵢ

If precedent clauses are homogeneous (all AND or all OR), then

FFᵢ = minimum ( ES_{j . . . m}) − ESᵢ − Dᵢ
If i has only one successor, then

If precedent clause is an AND, then

FFᵢ = minimum ( ESⱼ) − ESᵢ − Dᵢ

If precedent clause is an OR, then

FFᵢ = minimum ( ESⱼ) − ESᵢ − Dᵢ, where ESⱼ= EFᵢ

If precedent clause is OR and ESⱼ ≠ EFᵢ, then
FFᵢ = D_{G} −ESᵢ −Dᵢ

Total Float

For activity i, the Total Float (TFᵢ) is calculated:

TFᵢ=LF_{i -ES}ᵢ−Dᵢ

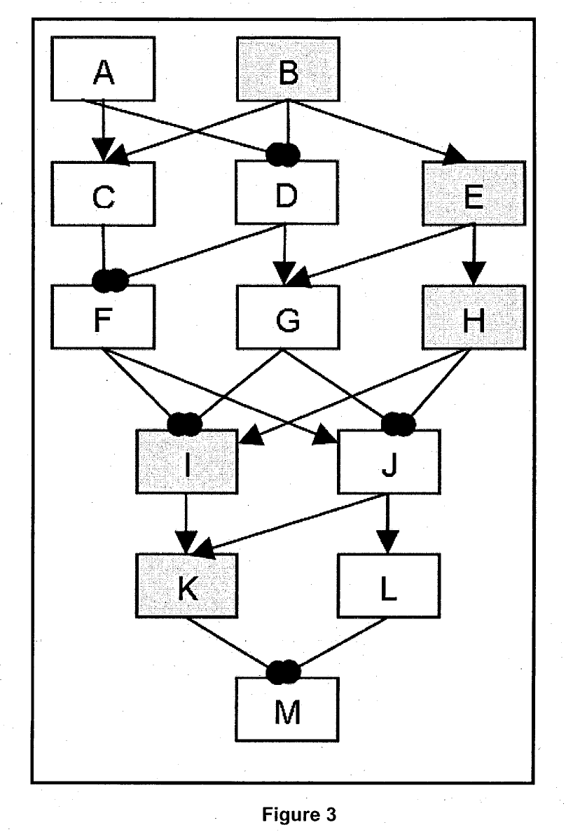

Table 1 displays the results obtained by running the generalized CPM algorithm of the present invention on the job stream shown in FIG. 1, where the job durations are assumed to be known (e.g., based on empirical data and statistical analysis thereof). FIG. 3 shows the job stream from FIG. 1 with the critical path shaded. Note that this example, for purposes of illustration, only shows success precedence types. It will be appreciated that other precedence types are supported by the present invention.

TABLE 1

| Activity | Duration | EarlyStart | EarlyFinish | LateStart | LateFinish | FreeFloat | TotalFloat | Precedence | Trig |
|---|---|---|---|---|---|---|---|---|---|
| A | 2 | 0 | 2 | 26 | 28 | 0 | 26 | none | none |
| B | 4 | 0 | 4 | 0 | 4 | 0 | 0 | none | none |
| C | 7 | 4 | 11 | 28 | 35 | 24 | 24 | A and B | B |
| D | 3 | 2 | 5 | 12 | 15 | 0 | 10 | A or B | A |
| E | 8 | 4 | 12 | 4 | 12 | 0 | 0 | B | B |
| F | 10 | 5 | 15 | 12 | 22 | 0 | 7 | C or D | D |
| G | 2 | 12 | 14 | 33 | 35 | 1 | 21 | D and E | E |
| H | 5 | 12 | 17 | 12 | 17 | 0 | 0 | E | E |
| I | 13 | 17 | 30 | 17 | 30 | 0 | 0 | (F or G) | H |
| | | | | | | | | and H | |
| J | 2 | 15 | 17 | 22 | 24 | 0 | 7 | (G or H) | F |
| | | | | | | | | and F | |
| K | 5 | 30 | 35 | 30 | 35 | 0 | 0 | I and J | I |
| L | 9 | 17 | 26 | 24 | 33 | 0 | 7 | J | J |
| M | 2 | 26 | 28 | 33 | 35 | 7 | 7 | K or L | L |

With regard to other precedence types such as “Termination” or “Failure”, these may be addressed in a variety of ways. In certain cases, such precedence types may be accommodated within the context of logical AND precedences without otherwise altering the critical path analysis. For example, a given job, say Job Z, may be executed if predecessor Job X is successful and predecessor Job Y fails. Such a contingency may not affect the critical path analysis in some cases. In such cases, the CPM algorithm would simply be executed as described above. That is, the CPM algorithm and associated logic can handle such disparate precedence types without concern regarding the precedence type definitions.

In other cases, such precedence types can be accommodated within the context of logical OR precedences. For example, Job Z may be executed if either Job X or Job Y fails, for example, to provide operational redundancy. Again, in certain cases, such contingencies may not affect the critical path analysis. In such cases, the CPM algorithm may proceed as described above.

In still other cases, accommodating different precedence types may result in “branching” of the critical path. In this regard, the activity on the node graph of FIG. 1 is a graphical representation of the information that would be provided to the CPM engine as a starting point for the CPM analysis. Such information about the job stream is provided by a scheduler, either through a direct interface using an appropriate API, or through an intermediate format, such as a well known file format. Modifications to a job stream can also be input by the user. Branching of the critical path may be due to, for example, IF, THEN, ELSE logic within the critical path. Thus, system redundancy may be provided by way of a job flow description requiring that Job Z be executed if Job A fails, or alternatively, Job X be executed if Job A succeeds. Thus, the job stream has two possible execution paths that must be analyzed. The input utility of the present invention can be used in conjunction with the CPM engine to address such situations by providing separate activity on node graphs addressing each contingency that may affect the critical path analysis. The CPM engine can process each one of these inputs as described above to provide separate CPM analyses. Thus, the input utility together with the CPM engine allow for simulation, analysis and optimization for differing precedence types, even where the associated contingencies may affect the critical path.

Floats

Table 1 shows two columns, Free Float (FF) and Total Float (TF). FF is the amount of time a job can either be delayed or increase in duration before delaying its successors. TF is the amount of time a job can be delayed or increase in duration before delaying the entire job stream of which it is a part. FF and TF are by definition both zero for a critical path job. For a non-critical path job TF is always greater than or equal to FF.

These floats represent “holes” within the overall execution of the job stream. By delaying non-critical path jobs by judicious use of the floats, it becomes possible to flatten machine loads.

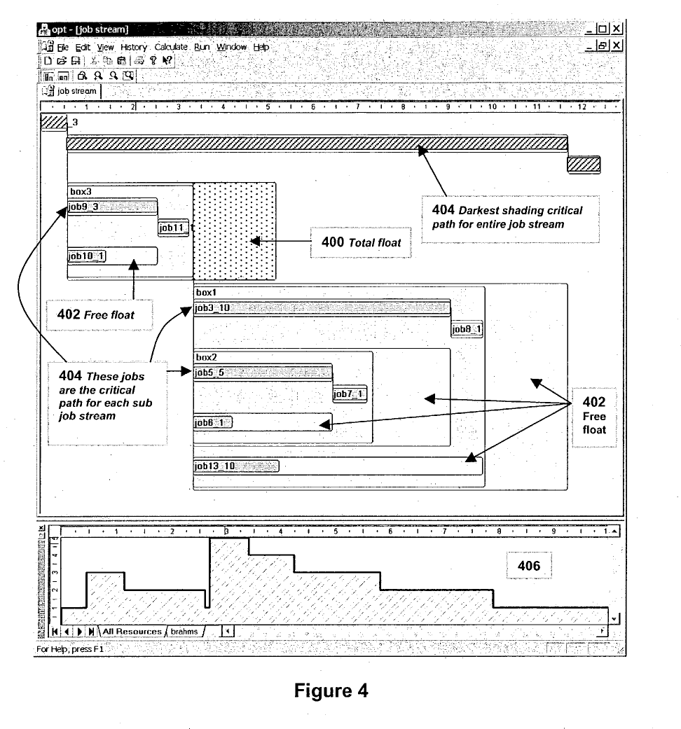

FIG. 4 shows a screen shot of the Optimizer™ system showing a modified Gantt style display of the opportunistic execution of the job stream shown in FIG. 2. Jobs and boxes are labeled with titles. Total Float, or the amount of time a job may either shift or increase in duration without delaying the finish of the entire job stream, is identified by the reference numeral 400. Free Float, the amount of time a job may either shift or increase in duration without delaying its immediate successors, is identified by the reference numeral 402. The critical path jobs for the entire job stream are shown with the darkest shading and identified by the reference numeral 404. In practice, these different elements may be color-coded.

Several interesting features can be gleaned from this display. The jobs with free float can effectively increase in duration consuming the entire available float without delaying their successors or the end of the entire job stream. In many schedulers it is possible to trigger an alarm (enterprise IT event which needs to be handled either by other software or technicians) when a job executes longer than deemed necessary. Using this display, or processing the underlying scheduling and float information independent of a display, it becomes possible to determine the amount of extra time needed before triggering an alarm. Indeed, in some cases alarms may be triggered unnecessarily as the perceived delay will have no bearing on the termination time of the job stream. In this regard, available float times and expected durations of successor jobs may be considered in determining a time for triggering an alarm. For example, an alarm may be triggered when a job is delayed at any time later than the scheduled end time for the job, for example, up to a time when all available float has been used such that the job is now on the critical path. An alternate time within the window thereby defined may be selected to generate an alarm so as to allow time for resolving problems without delaying job stream completion.

Of particular interest are the two smaller substreams, box1 and box2. As the entire job stream has a critical path, so do each of the encapsulated substreams. Critical paths 404 are always displayed at the top of each substream. However, it should be noted that the critical paths of box1 and box2 have some amount of free float. It is only within each substream that the critical path jobs have no float. This is an important point because it allows the leveling algorithm to borrow free float from a job stream and apply that float to jobs contained within it. In other words a job can inherit free float from its parent job stream even when, within that sub-schedule, it is a critical path job and has neither free or total float. Conversely, a parent job stream can legate float to its successor streams. It should be noted in this regard that boxes do not run on machines—they are only ephemeral abstractions to group related tasks with common precedences. Therefore the leveling algorithm discussed below concentrates on shifting jobs, not schedules.

Finally, the histogram display in the bottom pane 406 of FIG. 4 shows the machine loads. The pane has several tabs: one for each machine upon which the job stream runs and one which shows the sum of all machines.

Resource Leveling: Window of Opportunity

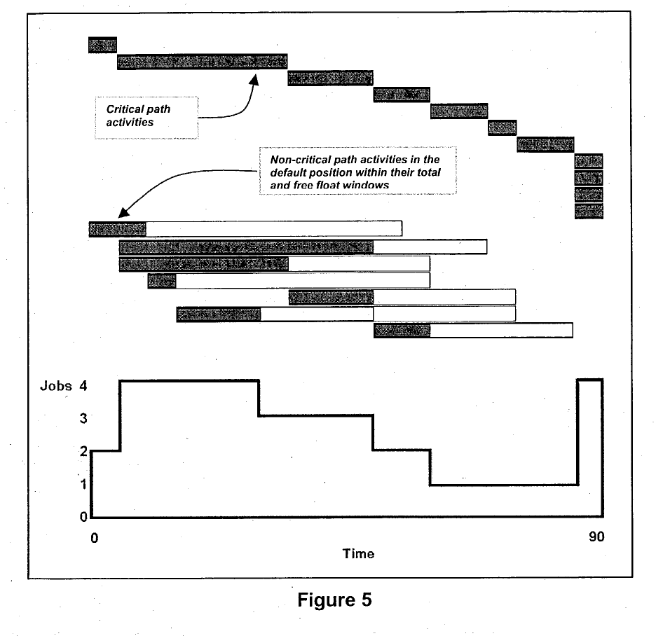

A job stream runs on a set of machines within an IT infrastructure. FIG. 5 shows a histogram representing job loads during a 90 minute job stream. From one to four jobs will be running at any given time.

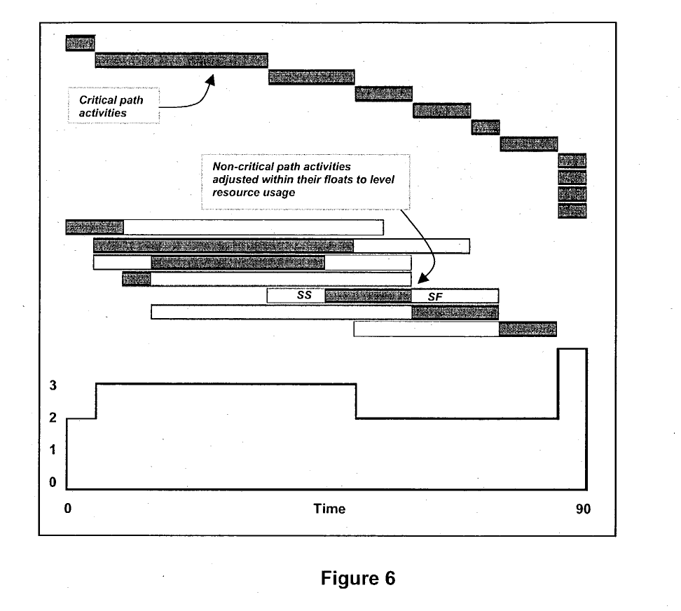

FIG. 6 shows a histogram of the job stream of FIG. 5 after resource leveling by using the Free Float (FF) to move non-critical path jobs within their respective windows together with a Gantt chart for the stream. This resource leveling algorithm is a modification of the basic Minimum Moment heuristic described by Robert B. Harris “Precedence and Arrow Networking Techniques for Construction”, 1978, Wiley & Sons., New York. The modification to the Minimum Moment heuristic is from Julio C. Martinez, “Resource Leveling Using the Generalized Minimum Moment Algorithm”, 1992, Technical Report UMCEE 92-14, University of Michigan. Briefly, the Minimum Moment heuristic involves generating a histogram that plots resource usage versus time and then shifting activities to find an improved histogram that has a minimized moment about the time axis. In this regard, a flat histogram would represent the assumed ideal resource allocation. To reduce the processing resources required to find a solution approximating the optimal solution, certain heuristics are applied to determine which activities to move in which sequence. The noted modification to the Minimum Moment heuristic relates to how activities are grouped for comparison to another so as to evaluate possible shifts to reduce the moment.

The Gantt chart above the histogram shows the non-critical jobs in their new positions within their Free Float windows as determined using the noted leveling algorithm. These new positions represent Scheduled Start (SS) and Scheduled Finish (SF). Now, the maximum number of jobs which run is only three. Note that resource leveling is aptly named as it lowers job load peaks by filling in job load valleys. The overall outcome is that the machine load is less for the given job stream. This in turn allows the jobs to run in less time decreasing the entire duration of the job stream.

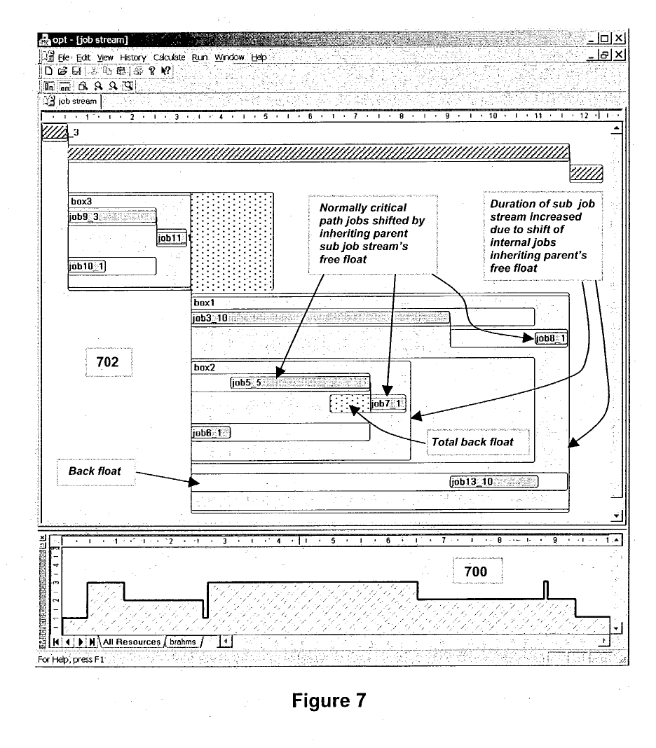

The ultimate goal of the Optimizer™ system is to calculate an alternate execution sequence that levels resource use across the enterprise. FIG. 7 shows the calculated solution for the job stream shown in FIG. 4. The resource histogram panel 700 shows the results of the leveling minimum moment algorithm. Using the generalized minimum moment heuristic, non-critical path jobs are repositioned within their Free Float window. A non-critical job with no Free Float still, by definition, must have some amount of Total Float. Since a Free Float of zero is indicative of successors, repositioning successors that have a non-zero Free Float in turn gives Free Float to the predecessor. By exploiting floats, the scheduler then can be used to delay jobs to periods of lower machine loads without delaying the overall job stream execution. In most cases, this alternate schedule is produced automatically, though there is an allowance for some user input that leverages job or machine specific knowledge. It is not a requirement that this specific knowledge be represented as an estimate or metric, the user can, on the Gantt style display chart shown in the top panel 702 of FIG. 7, simply “drag” non-critical path jobs to a new position (in essence, new start and end times) either creating an alternate schedule without the automated minimum moment heuristic (FIG. 6) leveling or just modifying the results of the heuristic. The modified Gantt style display clearly shows the shifted activities. In this regard, critical path jobs (if float has not been added as discussed below), may be “greyed out” or otherwise graphically identified as being unavailable to be moved. In addition, in the graphical user interface, non-critical path jobs may be constrained such that they cannot be moved beyond the limits of their calculated floats in connection with the noted drag-and-drop functionality. Upon moving a job, the Optimizer™ system is operative to automatically recalculate execution times and floats for all affected jobs.

In FIG. 7, both box1 and box2 have been extended in duration as a result of their internal jobs inheriting float. In box2, jobs job5_5 and job7_1 were on the critical path prior to leveling. After the leveling, both jobs have been shifted to later start times. A shifted job now displays back float, similar to free float in that any shift to an earlier start time will not cause a predecessor job to shift to an earlier start time. Also similar to total float is total back float, where a job, if shifted to an earlier start time will not cause the entire job stream to shift to an earlier start time.

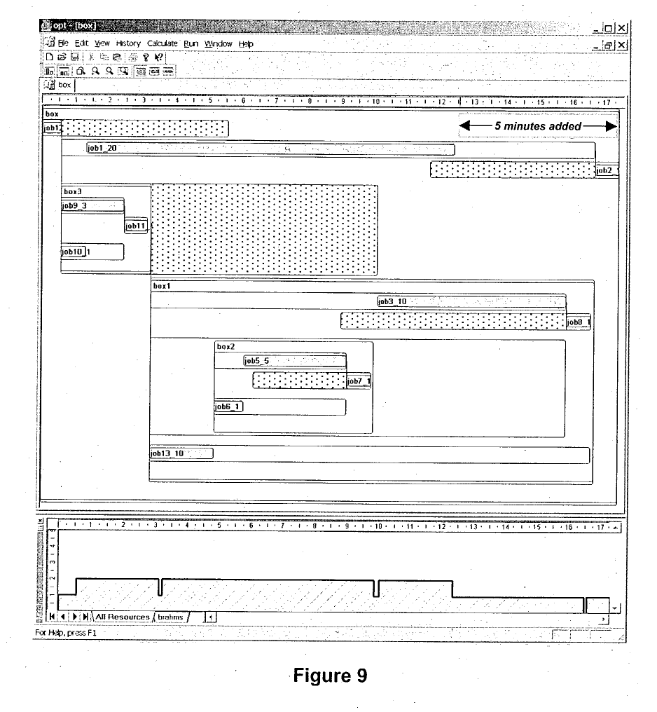

This particular solution is calculated within the minimum execution time of the entire schedule as indicated by the critical path jobs shown at the top of the Gantt display. In this way, it is possible to level the resource use by taking advantage of the free and total floats of the jobs and job streams not on the critical path. However, an alternate solution and one that can further level resource use is to give some amount of free float to the entire job stream. In other words the entire schedule can inherit free float much as the jobs inside a sub-job stream can inherit their parent's float. The Optimizer™ system, when the user chooses the Calculate menu choice, prompts the user for some amount of time to add to the entire displayed schedule. The default choice of zero time results in the minimum execution time shown in FIG. 7. The histogram display in FIG. 7 indicates that there are approximately five minutes where the resource load is 3 jobs running at the same time. If five minutes were added to the entire schedule, then the resource load would be further leveled resulting in loads of only two jobs running concurrently. This is shown in FIG. 9.

Execution of a Job Stream Using New Schedule

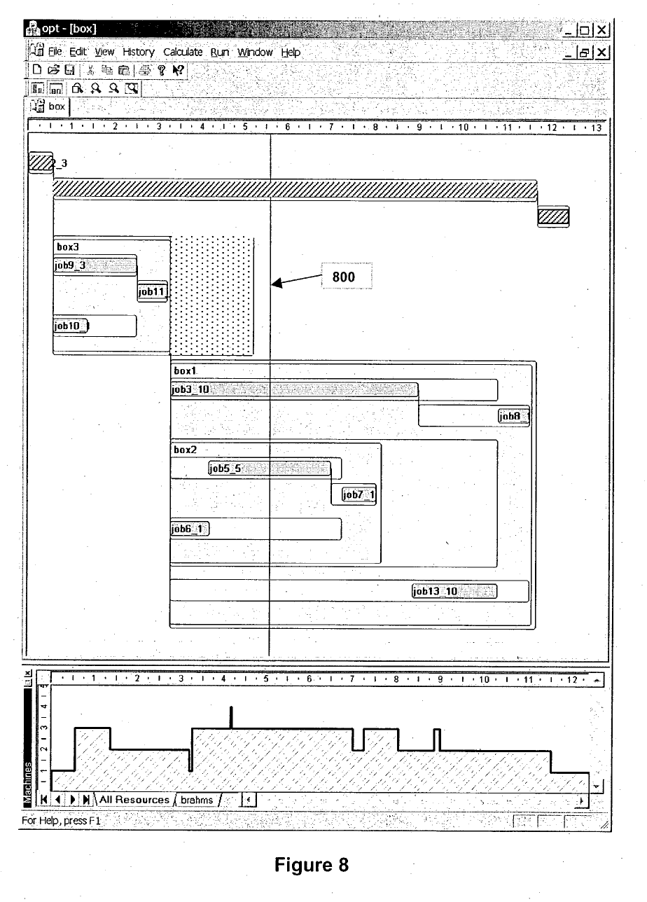

The Optimizer™ system now can be used to execute the job stream in collaboration with the scheduler. All commercially available schedulers allow some level of integration into the IT enterprise. This integration allows the enterprise to send and receive events to and from the scheduler. The Optimizer™ system uses this capability to execute and monitor a job stream. The application monitors or receives start, running and stop events while, at the same time, sends on-hold and off-hold events to the schedule. The on-hold and off-hold events are how the Optimizer™ system shifts the start time of a job. FIG. 8 shows the Optimizer™ system executing the job stream from FIG. 7. The vertical line 800 indicates the current time in the execution sequence. The Optimizer™ system constantly recalculates the Critical path and the leveling solution upon receiving start, running and stop events. In this way, fluctuations in execution duration of any job or sub-job stream are handled dynamically. This includes any job shifted or un-shifted which executes longer than its available free or total float causing a shift in critical path.

The initial historical times representing the default or opportunistic execution from which the critical path and leveling solution are calculated constitute an approximate model of the execution behavior. This model can be adjusted dynamically during execution constantly re-calculating to ensure minimum resource use.

Once the new schedule has been executed, the schedule can be saved to a file using a get/save format. Since all of the execution times, floats and shifts are stored in this file it is not necessary to obtain historical data from the scheduler the next time the Optimizer™ system executes the schedule. The file is just loaded back into the application and the user can either recalculate a new schedule by adding some float to the entire schedule to further level resources or just simple choose the Run menu option.

Modifications

The Optimizer™ system also will allow the user to modify run times or change the job stream by adding jobs and estimated runtimes or removing jobs. In this way the user can manage growth as it happens. This is achieved by incremental loading of JIL files with estimated duration times inserted using the start_time and end_time tags as mentioned earlier. It is not necessary to obtain historical run-times for the jobs. Even though these are time estimates, once the modified job stream has been executed these estimated times are replaced with actual times. Since the Optimizer™ system dynamically adjusts shifts during execution, the estimated times have a minimal impact on the resource leveling.

The scheduler executes the job stream. During this run-time phase, the Optimizer system interfaces with the scheduler and monitors the job stream closely to determine that execution windows (start to finish), for each job, fall within the simulated limits of the optimized schedule. Then, when appropriate, the Optimizer system commands the scheduler to delay certain jobs in order to level machine loads. Since the Optimizer system is monitoring run-times constantly, the data is stored in the model allowing schedule refinements to occur during a subsequent analysis-simulation phase.

Modeling

The Optimizer™ system also will allow the user to modify run times or change the job stream by adding jobs and estimated runtimes or removing jobs. The analysis and simulation steps can then be performed to determine predicted machine loads before and after a proposed alternate schedule. In this way the user can manage growth as it happens.

While various embodiments of the present invention have been described in detail, it is apparent that further modifications and adaptations of the invention will occur to those skilled in the art. However, it is to be expressly understood that such modifications and adaptations are within the spirit and scope of the present invention.

What is claimed:

1. A method for use in analyzing job streams, comprising the steps of:
receiving input information defining a job stream including arbitrary precedence logic, said job stream involving a number of jobs to be executed using a defined resource set, said jobs including multiple predecessor jobs and multiple successor jobs that may be the same or different than the predecessor jobs, where an execution of each of said successor jobs is dependent on an outcome of one or more of said predecessor jobs, and said arbitrary precedence logic includes at least one AND precedence set such that execution of first successor job is dependent on an outcome of each of two or more of said predecessor jobs and at least one OR precedence set such that execution of a second successor job, that may be the same or different than said first successor job, is dependent on an outcome of less than all of two or more predecessor jobs;
first configuring a first processor to execute a Critical Path Method (CPM) algorithm adapted to handle said arbitrary precedence logic, said CPM algorithm involving the identification of a job path within said job stream wherein each job of said job path has an identical early start and late start time upon proper application of all associated precedences; and
first employing said processor to process said job stream using said CPM algorithm.

2. A method as set forth in claim 1, wherein said job stream is a batch process job stream of a computer network.

3. A method as set forth in claim 1, wherein said step of first employing comprises simulating said job stream using said CPM algorithm.

4. A method as set forth in claim 1, wherein said step of first employing comprises analyzing said job stream using said CPM algorithm.

5. A method as set forth in claim 1, wherein said step of first employing comprises optimizing said job stream using said CPM algorithm.

6. A method as set forth in claim 1, further comprising the steps of:
second configuring a second processor, which may be the same as or different than said first processor, to execute a resource leveling algorithm based at least in part on said CPM algorithm, said resource leveling algorithm being directed to moderating a usage extremum of at least one resource of said defined resource set, said extremum being one of a relative minimum usage level of said resource and a relative maximum usage level of said resource; and
second employing said second processor to process said job stream using said resource leveling algorithm.

7. A method as set forth in claim 6, wherein said step of second employing comprises identifying a non-critical path job and rescheduling said non-critical path job.

8. A method as set forth in claim 1, wherein said step of first configuring comprises executing said algorithm so as to handle arbitrary precedent types, said arbitrary precedence types including at least a first outcome type relating to a first outcome of a first predecessor job and a second outcome type, different than said first outcome type, relating to a second outcome of a second predecessor job.

9. A method as set forth in claim 1, wherein said first processor is further operative for determining a first float of a first job and a second float of a second job related to said first job, said second float including a transferred portion associated with said first float of said first job.

10. A method as set forth in claim 1, wherein said job stream includes a parent object and first and second child objects and said processor is operative to determine a float of one of said first and second child objects that is due at least in part to an inheritance from the parent object.

11. A method as set forth in claim 8, wherein said second float is comprised entirely of said inherited portion associated with said first float of said first predecessor job.

12. A method as set forth in claim 1, wherein said first processor is further operative for graphically depicting, on a graphical user interface, output information including float for at least one job of said predecessor jobs and successor jobs.

13. A method as set forth in claim 12, wherein said first processor is further operative for executing changes to a schedule of said job stream in response to user inputs entered relative to said graphical user interface.

14. A method as set forth in claim 1, wherein said first processor is operative for determining a float for a first job of said predecessor and successor jobs and for making a determination regarding a time for triggering an alarm concerning a delay in completion of said first job, said determination being based at least in part on said float of said first job.

15. A method as set forth in claim 1, wherein said first processor is operative to add a float to said entire job stream and use said float to schedule execution of said job stream.

16. A method as set forth in claim 1, wherein said first processor is further operative for monitoring execution of said job stream and dynamically rescheduling jobs of said job stream based on said monitoring.

17. A method for use in analyzing job streams, comprising the steps of:
receiving input information defining a job stream including arbitrary precedence types, said job stream involving a number of jobs to be executed using a defined resource set, said jobs including multiple predecessor jobs and multiple successor jobs that may be the same or different than the predecessor jobs, where an execution of each of said successor jobs is dependent on an outcome of one or more of said predecessor jobs, and said arbitrary precedence types include at least a first outcome type relating to a first outcome of a first predecessor job and a second outcome type, different than said first outcome type, relating to a second outcome of a second predecessor job;
first configuring a first processor to execute a Critical Path Method (CPM) algorithm adapted to handle said arbitrary precedence types, said CPM algorithm involving the identification of a job path within said job stream wherein each job of said job path has an identical early start and late start time upon proper application of associated precedences; and
first employing said processor to process said job stream using said CPM algorithm.

18. A method as set forth in claim 17, wherein said job stream is a batch process job stream of a computer network.

19. A method as set forth in claim 17, wherein said step of first employing comprises simulating said job stream using said CPM algorithm.

20. A method as set forth in claim 17, wherein said step of first employing comprises analyzing said job stream using said CPM algorithm.

21. A method as set forth in claim 17, wherein said step of first employing comprises optimizing said job stream using said CPM algorithm.

22. A method as set forth in claim 17, further comprising the steps of:
second configuring a second processor, which may be the same as or different than said first processor, to execute a resource leveling algorithm based at least in part on said CPM algorithm, said resource leveling algorithm being directed to moderating a usage extremum of at least one resource of said defined resource set, said extremum being one of a relative minimum usage level of said resource and a relative maximum usage level of said resource; and
second employing said second processor to process said job stream using said resource leveling algorithm.

23. A method as set forth in claim 17, wherein said step of second employing comprises identifying a non-critical path job and rescheduling said non-critical path job.

24. A method as set forth in claim 17, wherein said first processor is further operative for determining a first float of a first job and a second float of a second job related to said first job, said second float including a transferred portion associated with said first float of said first job.

25. A method as set forth in claim 17, wherein said first processor is further operative for graphically depicting, on a graphical user interface, output information including float for at least one job of said predecessor jobs and successor jobs.

26. A method as set forth in claim 25, wherein said first processor is further operative for executing changes to a schedule of said job stream in response to user inputs entered relative to said graphical user interface.

27. A method as set forth in claim 17, wherein said first processor is operative to add a float to said entire job stream and use said float to schedule execution of said job stream.

28. A method as set forth in claim 17, wherein said first processor is further operative for monitoring execution of said job stream and dynamically rescheduling jobs of said job stream based on said monitoring.

29. A method for use in analyzing job streams, comprising the steps of:
receiving input information defining a job stream involving a number of jobs to be executed using a defined resource set, said jobs including multiple predecessor jobs and multiple successor jobs that may be the same or different than the predecessor jobs, where an execution of each of said successor jobs is dependent on a completion of one or more of said predecessor jobs;
first configuring a first processor to execute a resource leveling algorithm directed to moderating a usage extremum of at least one resource of said defined resource set, said extremum being one of a relative minimum usage level of said resource and a relative maximum usage level of said resource; and
first employing said first processor to process said job stream using said resource leveling algorithm.

30. A method as set forth in claim 29, wherein said job stream is a batch process job stream of a computer network.

31. A method as set forth in claim 29, wherein said step of first employing comprises identifying a non-critical path job and rescheduling said non-critical path job.

32. A method as set forth in claim 29, wherein said first processor is operative to execute a critical path method algorithm adapted to handle arbitrary precedence logic, said arbitrary precedence logic including at least one AND precedence set such that execution of a first successor job is dependent on an outcome of each of two or more predecessor jobs and at least one OR precedence set such that execution of a second successor job, that may be the same or different than said first successor job, is dependent on an outcome of less than all of two or more predecessor jobs.

33. A method as set forth in claim 29, wherein said first processor is operative to execute a critical path method algorithm adapted to handle arbitrary precedence types, said arbitrary precedence types including at least a first outcome type relating to a first outcome of a first predecessor job and a second outcome type, different than said first outcome type, relating to a second outcome of a second predecessor job.

34. A method as set forth in claim 29, wherein said first processor is operative for determining a first float of a first job and a second float of a second job related to said first job, said second float including a transferred portion associated with said first float of said first job.

35. A method as set forth in claim 29, wherein said first processor is further operative for graphically depicting, on a graphical user interface, output information including float for at least one job of said predecessor jobs and successor jobs.

36. A method as set forth in claim 35, wherein said first processor is further operative for executing changes to a schedule of said job stream in response to user inputs entered relative to said graphical user interface.

37. A method as set forth in claim 29, wherein said first processor is operative to add a float to said entire job stream and use said float to schedule execution of said job stream.

38. A scheduler, comprising:
input structure configured to receive input information defining a job stream including arbitrary precedence logic, said job stream involving a number of jobs to be executed using a defined resource set, said jobs including multiple predecessor jobs and multiple successor jobs that may be the same or different than the predecessor jobs, where an execution of each of said successor jobs is dependent on an outcome of one or more of said predecessor jobs, and said arbitrary precedence logic includes at least one AND precedence set such that execution of first successor job is dependent on an outcome of each of two or more of said predecessor jobs and at least one OR precedence set such that execution of a second successor job, that may be the same or different than said first successor job, is dependent on an outcome of less than all of two or more predecessor jobs;
processing structure configured to execute a Critical Path Method (CPM) algorithm adapted to handle said arbitrary precedence logic, said CPM algorithm involving the identification of a job path within said job stream wherein each job of said job path has an identical early start and late start time upon proper application of all associated precedences; and
output structure for providing an output based on processing of the job stream by said processing structure using the CPM algorithm.

39. A scheduler as set forth in claim 38, wherein said processing structure is configured to execute said algorithm so as to handle arbitrary precedence types, said arbitrary precedence types including at least a first outcome type relating to a first outcome of a first predecessor job and a second outcome type, different than said first outcome type, relating to a second outcome of a second predecessor job.

40. A scheduler as set forth in claim 38, wherein said input structure is configured to execute a resource leveling algorithm based at least in part on said CPM algorithm, said resource leveling algorithm being directed to moderating a usage extremum of at least one resource of said defined resource set, said extremum being one of a relative minimum usage level of said resource and a relative maximum usage level of said resource.

41. A scheduler, comprising:
input structure configured to receive input information defining a job stream including arbitrary precedence types, said job stream involving a number of jobs to be executed using a defined resource set, said jobs including multiple predecessor jobs and multiple successor jobs that may be the same or different than the predecessor jobs, wherein execution of each of said successor jobs is dependent on an outcome of one or more of said predecessor jobs, and said arbitrary precedence types include at least a first outcome type relating to a first outcome of a first predecessor job and a second outcome type, different than said first outcome type, relating to a second outcome of a second predecessor job;
processing structure configured to execute a critical path method algorithm adapted to handle said arbitrary precedence types, said CPM algorithm involving the identification of a job path within said job stream, wherein each job of said job path has an identical Early Start and Late Start time upon proper application of said associated precedences; and
output structure for providing an output based on processing of the job stream by said processing structure using the CPM algorithm.

42. A scheduler as set forth in claim 41, wherein said processing structure is operative to execute a resource leveling algorithm based at least in part on said CPM algorithm, said resource leveling algorithm being directed to moderating a usage extremum of at least one resource of said defined resource set, said extremum being one of a relative minimum usage level of said resource and a relative maximum usage level of said resource.

43. A method for use in analyzing job streams, comprising the steps of:
receiving input information including a definition of a job stream involving a number of jobs to be executed using a defined resource set;
identifying a parent object of said job stream having first and second child objects;
identifying a float associated with the parent object; and
first configuring a first processor to execute logic for determining a second float associated with one of the first and second child objects, said second float defining a temporal flexibility for at least one of a start time and an end time for executing said one of the first and second child objects, said second float including an inherited portion associated with a first float of said first parent object.

44. A method as set forth in claim 43, wherein said job stream is a batch process job stream of a computer network.

45. A method as set forth in claim 43, wherein said first float of said parent object is dependent on a scheduling of a predecessor object.

46. A method as set forth in claim 43, wherein said logic is operative for determining floats for each of first and second child objects based at least in part on said inherited portion of said float.

47. A method as set forth in claim 43, wherein said parent object comprises a substream including multiple jobs and associated dependencies.

48. A method as set forth in claim 43, wherein said inherited float comprises less than the whole of said second float.

49. A method for use in analyzing job streams, comprising the steps of:
receiving input information defining a number of jobs to be executed using a defined resource set, said jobs including multiple predecessor jobs and multiple successor jobs that may be the same or different than the predecessor jobs, where an execution of each of said successor jobs is dependent on a completion of one or more of said predecessor jobs; and
operating a computer system to determine and graphically depict, on a graphical user interface, output information including float for at least one of said number of jobs, where said float relates to a temporal flexibility of at least one of a start time and an end time for a subject job.

50. A method as set forth in claim 49, wherein said job stream is a batch process job stream of a computer network.

51. A method as set forth in claim 49, wherein said computer system is further operative for executing changes to a schedule of said number of jobs and response to user inputs entered relative to said graphical user interface.

52. A method for use in analyzing job streams, comprising the steps of:
receiving input information defining a job stream involving a number of jobs to be executed using a defined resource set, said jobs including multiple predecessor jobs and multiple successor jobs that may be the same or different than the predecessor jobs, where an execution of each of said successor jobs is dependent on a completion of one or more of said predecessor jobs;
first operating a computer system to graphically depict, on a graphical user interface, a usage graph reflecting a usage level of at least one resource of said resource set over a time period corresponding to execution of at least a portion of said job stream according to a first job stream schedule;
receiving, relative to said graphical user interface, a user input for altering a portion of said usage graph; and
second operating said computer system to alter said first job stream schedule based on said user input.

53. A method as set forth in claim 52, wherein said job stream is a batch process job stream of a computer network.

54. A method as set forth in claim 46, wherein said computer system is further operative to graphically depict output information including float for at least one job of said job stream.

55. A method for use in analyzing job streams, comprising the steps of:
receiving input information defining a job stream involving a number of jobs to be executed using a defined resource set, said jobs including multiple predecessor jobs and multiple successor jobs that may be the same or different than the predecessor jobs, where an execution of each of said successor jobs is dependent-on a completion of one or more of said predecessor jobs;
first operating a computer system to determine, for a first job of said number of jobs, first information related to an execution time of said first job and second information relating to a float time of said first job; and
second operating said computer system to make a determination regarding a time for triggering an alarm concerning a delay in completion of said first job, said determination being based at least in part on said second information relating to said float time of said first job.

56. A method as set forth in claim 55, wherein said job stream is a batch process job stream of a computer network.

57. A method as set forth in claim 55, wherein said first job has a scheduled end time followed by a float time and said step of second operating comprises identifying said time for triggering said alarm as being later than said scheduled end time but not later than an end of said float time.

58. A method for use in analyzing a job stream, comprising the steps of:
receiving input information defining a job stream involving a number of jobs to be executed using a defined resource set, said jobs including multiple predecessor jobs and multiple successor jobs that may be the same or different than the predecessor jobs, where an execution of each of said successor jobs is dependent on a completion of one or more of said predecessor jobs;
identifying first and second subsets of said job stream, said first subset of said job stream including at least a first job, said first subset being a predecessor within a context of said job stream to said second subset of said job stream, said second subset including at least a second job, wherein said definition of said job stream requires that said first subset is at least partially executed prior to said second subset;
second identifying a critical path relative to said second subset, where each critical path job on said critical path has zero float time such that a delay of any one of said critical path jobs results in a delay in completion of said second subset;
third identifying a first subset float time relating to a temporal flexibility in executing said first subset without delaying completion of said job stream; and
using said first subset float time to establish an execution time of a critical path job of said second subset.

59. A method as set forth in claim 58, wherein said job stream is a batch process job stream of a computer network.

60. A method for use in analyzing a job stream, comprising the steps of:
receiving input information defining a job stream involving a number of jobs to be executed using a defined resource set, said jobs including multiple predecessor jobs and multiple successor jobs that may be the same or different than the predecessor jobs, where an execution of each of said successor jobs is dependent on a completion of one or more of said predecessor jobs;
operating a computer system to identify a back float for a first successor job of said successor jobs, said back float relating to a flexibility to move a scheduled starting time of said first successor job to an earlier time without rescheduling a preceding one of said predecessor jobs; and
using said back float to determine an actual starting time for said first successor job.

61. A method as set forth in claim 60, wherein said job stream is a batch process job stream of a computer network.

62. A method as set forth in claim 60, wherein said step of using said back float comprises executing a resource leveling algorithm directed to moderating a usage extremum of at least one resource of a defined resource set, said extremum being one of a relative minimum usage level of said resource and a relative maximum usage level of said resource.

63. A method for use in analyzing a job stream, comprising the steps of:
receiving input information defining a job stream involving a number of jobs to be executed using a defined resource set, said jobs including multiple predecessor jobs and multiple successor jobs that may be the same or different than the predecessor jobs, where an execution of each of said successor jobs is dependent on a completion of one or more of said predecessor jobs;
first operating a computer system to add a float time to said entire job stream, said float time relating to a temporal flexibility for an execution time of said job stream; and
second operating said computer system to use said input information and said added float time to schedule execution of said job stream.

64. A method as set forth in claim 63, wherein said job stream is a batch process job stream of a computer network.

65. A method as set forth in claim 63, wherein said step of first operating comprises selecting said float time from a predefined menu of float times.

66. A method as set forth in claim 63, wherein said step of second operating comprises executing a resource leveling algorithm directed to moderating a usage extremum of at least one resource of said defined resource set, said extremum being one of a relative minimum usage level of said resource and a relative maximum usage level of said resource.
